(19) United States
(12) Patent Application Publication
(10) Pub. No.: US 2015/0002636 A1
(43) Pub. Date: Jan. 1, 2015

(54) Capturing Full Motion Live Events Using Spatially Distributed Depth Sensing Cameras

(71) Applicant: Cable Television Laboratories, Inc., Louisville, CO (US)

(72) Inventor: Ralph W. Brown, Boulder, CO (US)

(21) Appl. No.: 13/931,484

(22) Filed: Jun. 28, 2013

(51) Int. Cl. H04N 13/02

(52) U.S. Cl. CPC H04N 13/0282
USPC 348/47

(57) ABSTRACT

Real-time, full-motion, three-dimensional models are created for reproducing of a live event is performed by means of a plurality of depth sensing cameras. The plurality of depth sensing cameras are used to acquire a time sequence of two-dimensional images plus depth information of the event from a plurality of different viewing directions, wherein the acquiring of the two-dimensional images plus depth information of each of at least some scenes in the event by the cameras occurs substantially simultaneously. The time sequence of two-dimensional images plus depth information acquired by the plurality of depth sensing cameras are combined to create a time sequence of three-dimensional models of the live event. Optionally, a plurality of rendering systems may be used to reproduce the live event from the time sequence of three-dimensional models for display to a plurality of end-users.

### BACKGROUND OF THE INVENTION

This invention relates in general to systems and methods for capturing live events, and in particular to systems and methods for capturing full motion live events in color using spatially distributed depth sensing cameras.

Conventional 3D stereoscopic video of live action today is done by having a two-camera or stereo-camera rig (movies like Life of Pi and sports events that are broadcast in 3D stereoscopic video have used this technology). This is intended to provide a stereoscopic view (left/right image) of the live action from a particular perspective on the action. It is not possible to shift the perspective other than by moving the camera rig. It is not possible to see behind the objects or see around objects in the scene, because one only has that specific perspective recorded by the camera. In other words, once the action has been recorded by the camera one cannot change the perspective of the stereo view. The only way to do that is to move the camera to the new location and reshoot the action. In live sports events this isn't possible, unless the players can be convinced to run the play again exactly the way they did before.

In some football games, more than one camera is used to record the game from more than one perspective, and in the replay, the scenes are frozen and displayed from the perspective of one of the cameras. However, this is quite different from being able to reproduce the live event from any perspective.

It is therefore desirable to provide a technique that is capable of capturing full motion live events from any perspective on the event as it happens, so that the live event may be re-enacted.

### SUMMARY OF THE INVENTION

In one embodiment, a system for creating real-time, full-motion, three-dimensional models for reproducing a live event comprises a plurality of depth sensing cameras acquiring a time sequence of two-dimensional images plus depth information of the event from a plurality of different viewing directions, and a circuit synchronizing the plurality of depth sensing cameras to acquire the two-dimensional images plus depth information of each of at least some scenes in the event substantially simultaneously. The system further includes a device combining the two-dimensional images plus depth information acquired by the plurality of depth sensing cameras substantially simultaneously to create a time sequence of three-dimensional models of the live event. The system may also include as an option a plurality of rendering systems reproducing the live event from the time sequence of three-dimensional models for display to a plurality of end-users.

In another embodiment, a method for creating a real-time, full-motion, three-dimensional models for reproducing of a live event is performed by means of a plurality of depth sensing cameras. The method comprises using the plurality of depth sensing cameras to acquire a time sequence of two-dimensional images plus depth information of the event from a plurality of different viewing directions, wherein the acquiring of the two-dimensional images plus depth information of each of at least some scenes in the event by the cameras occurs substantially simultaneously; and combining the time sequence of two-dimensional images plus depth information acquired by the plurality of depth sensing cameras to create a time sequence of three-dimensional models of the live event.

All patents, patent applications, articles, books, specifications, other publications, documents and things referenced herein are hereby incorporated herein by this reference in their entirety for all purposes. To the extent of any inconsistency or conflict in the definition or use of a term between any of the incorporated publications, documents or things and the text of the present document, the definition or use of the term in the present document shall prevail.

### BRIEF DESCRIPTION OF THE DRAWINGS

FIG. 1 is a view of a scene from a single perspective.

FIG. 2 is a view of a scene from a single perspective showing an area of occlusion between two objects.

FIG. 3 is a graphical plot illustrating a transform of image plus depth to object location to illustrate one embodiment of the invention.

FIG. 4 is a graphical plot illustrating an example venue with four spatially diverse cameras to illustrate one embodiment of the invention.

FIG. 5 is a graphical plot illustrating an alternative view of the four spatially diverse cameras of FIG. 4.

FIG. 6 is a flowchart illustrating one embodiment of the invention.

FIG. 7 is a block diagram of a system that captures full motion live events in color using spatially distributed depth sensing cameras, and reproduces the live events from any perspective.

### DETAILED DESCRIPTION OF EXEMPLARY EMBODIMENTS

One embodiment of the invention is based on the recognition that for reproduction of a full motion live event, a time sequence of 3D computer models of the sequential scenes of the full motion live event is first generated from 2D images plus depth information and these models are then used for the reproduction of the full motion live event from any perspective. The 2D images plus depth information may be obtained using a plurality of depth sensing cameras placed spatially apart around the live event.

Most of today's 3D stereoscopic movies are actually computer generated imagery (CGI) (e.g. movies like UP, Wreck it Ralph, and many, many others). Like many of today's game console games, these movies are generated by creating a 3D computer model of the scene and then the stereo animation is generated through a virtual stereo camera rig that renders the scene twice, one for the left eye and one for the right eye, separate by the average distance between the eyes in humans. The advantage of this virtual world is that it relies on a computer model, so one can replay and render the scene any number of times precisely the same way, from any vantage point one chooses. Whether one renders a conventional 2D representation (non-stereo) or a stereo representation is only a matter of how one chooses to render it (rendering once 2D or twice for stereo). The key is that a virtual 3D model is used that can be animated and viewed from any perspective. Thus, in one embodiment of the invention, a virtual 3D model representation of the real world is generated instead of a virtual 3D model, from data obtained from scenes of the live event in a manner as explained below. In a subsequent rendering process, the live event can then be reproduced from any perspective one chooses, similar to the rendering process using a virtual 3D model.

Many types of depth sensing cameras may be used for obtaining the data of the live event, where the data is then used for constructing the 3D models. One of these types is the flash LIDAR camera. For an explanation of the LIDAR camera and its operation, please see “REAL-TIME CREATION AND DISSEMINATION OF DIGITAL ELEVATION MAPPING PRODUCTS USING TOTAL SIGHT™ FLASH LiDAR”, Eric Coppock, et. al., ASPRS 2011 Annual Conference, Milwaukee, Wis., May 1-5, 2011 (http://www.asprs.org/a/publications/proceedings/Milwaukee2011/files/Coppock.pdf). The objective of the spatially distributed flash LIDAR cameras is to capture a full motion, complete three-dimensional model, with color imaging of live events. Similar to sports games played on game consoles with rich three-dimensional virtual environments that can be used to generate full motion video of the action that is viewable from any perspective, this invention creates a virtual 3D representation of the real world with the real actors, team members, and objects that can in the same way be viewed from any perspective. It is a way to virtualize the real-world in real-time so that it can be spatially manipulated to permit viewing the action from any perspective within the volume of space captured by the cameras.

A flash LIDAR camera captures full motion video with each pixel in the image represented by an intensity, a color and distance from the camera (e.g. Red, Green, Blue, and Depth) at a certain frame rate, such as 30 frames-per-second, from the perspective at the location of the camera. This representation (R,G,B,d) is often called a 2D plus depth representation. If a number of spatially distributed flash LIDAR cameras are used, where the cameras are synchronized to capture substantially simultaneously 2D plus depth representation of the same scene of the time sequence of scenes in the live event, then the time sequence of 2D representation images plus depth information so obtained from the LIDAR cameras may be combined to derive a time sequence of full motion, complete three-dimensional models. These models can then be used in a rendering process to re-create the live event that can then be viewed from any perspective within the venue, either on the field/stage or in the audience. In theory the same information could be synthesized from the use of a plenoptic or light-field camera (e.g. Lytro camera, www.lytro.com) or other form of camera array. Regardless of the technology employed, either flash LIDAR camera or light-field camera, or any other camera that may be used in this manner, is within the scope of the invention, and will be referred to generically as a camera herein.

One embodiment of this invention uses the 2D plus depth information from the multiple perspectives of a number of spatially distributed cameras to synthesize this 3D computer model of the real-world action as it unfolds. By having this 3D computer model, one can be positioned at a location anywhere one wants and view the action of the event from that vantage point as reproduced using the 3D computer model of the real-world action, instead of from the fixed vantage point of a single camera (either 2D or stereoscopic).

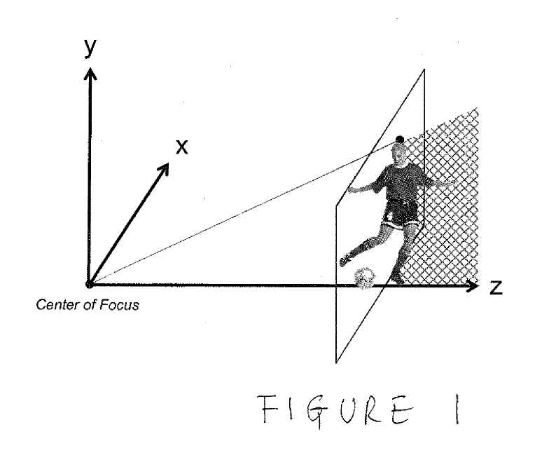

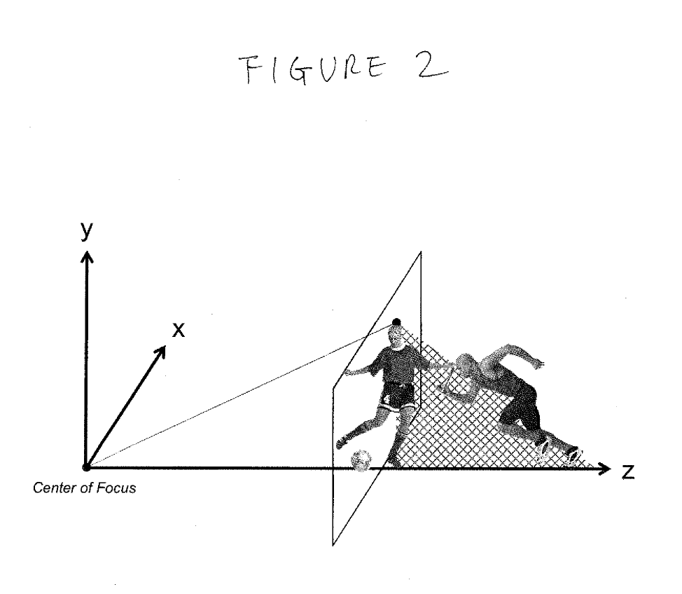

A single camera can capture a full motion, three-dimensional model, with color imaging from a single perspective. In other words, it is only possible to render the resulting 3D model from a limited range of perspectives. For example, in FIG. 1, the soccer player is from the left side only (soccer player's right side). It is not possible to view the other side of the soccer player (shaded area), as there is no depth information captured behind the object or scene. Further, objects in the foreground may occlude objects in the background, masking the depth data between the two objects. In order to capture a complete three-dimensional model it is necessary to capture the object or scene from multiple perspectives, consequently multiple spatially distributed cameras are required. For example, to capture a full 360-degree range of perspectives a minimum of two cameras separated by 180 degrees is required, one from a front view and one from a back view. This is sufficient for a simple scene with a limited number of objects that do not occlude each other. However, when objects or people in the scene occlude the view of other objects from the perspective of the camera, information is concealed and it is not possible to accurately view the space that falls between the two objects, as is shown by the shaded region in FIG. 2.

It is necessary to have views from other perspectives to fill in the occluded information or alternatively attempt to algorithmically synthesize the information in the occluded space. This is significantly more complicated when there are many objects or players in volume captured by the two cameras. By adding more spatially distributed cameras one can synthesize a more accurate model of the action. Where the live event occurs on stage, a minimum of two cameras separated by 90 degrees is required to build the 3D models, each viewing the stage from a 45 degree angle away from the front edge of the stage and the cameras cover a 90 degree surrounding view of the event.

Probably the easiest way to think about this is that this is a 3 dimensional stitching process to join the multiple perspectives. A panoramic 2D picture can be generated by stitching together a series of 2D pictures (http://en.wikipedia.org/wiki/Panoramic_photography#Segmented). In this case, rather than rotating the camera to generate a panorama, we are essentially rotating (positioning) the camera around the scene to get a full 360 degree view of the action.

The stitching in 3D is first accomplished by putting the 2D plus depth information into the same point of reference. This is done by use of a coordinate transformation from each camera's frame of reference to a common frame of reference that represents the scene or venue (e.g. NE corner of the football field). Once this is done one will have a voxel or volumetric representation with location in 3 dimensions and a color and/or brightness reading from each camera. Where the cameras have a voxel at the same point in 3 dimensions the color at that point in space can be arrived at by a blending (i.e. averaging) or stitching process. Where such location is not visible from some cameras, the color and/or brightness of only the voxel or voxels from the camera or cameras that do have data at that point in space are used in the blending or stitching process. A similar process may be used for arriving at the light intensity or brightness of a voxel.

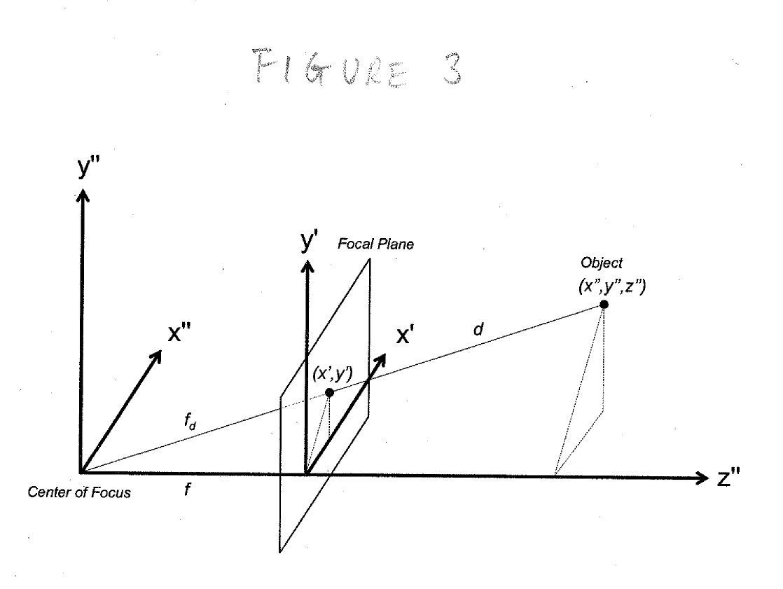

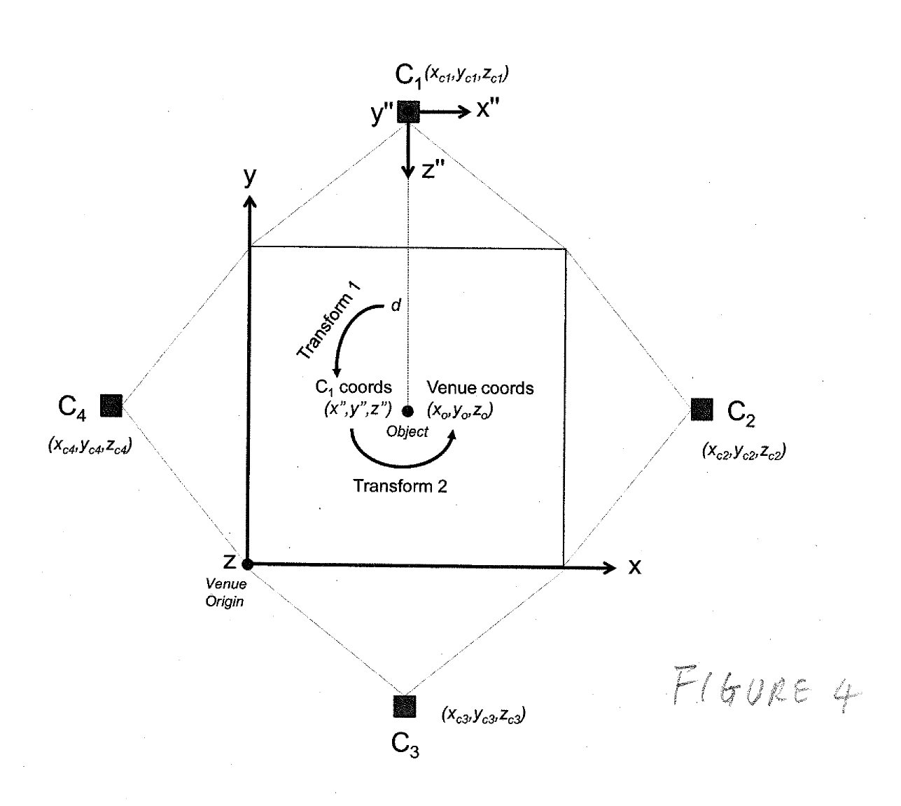

The following discussion will use four spatially distributed cameras, each placed on the four compass directions around the field (see FIG. 3). While four cameras reduce the problem of occlusion significantly, it still may occur and the use of more cameras, for example 8 or 16 will reduce the occlusion problem further. To combine the output of the four cameras, the camera positions are precisely calibrated to a common reference point, as well as the camera orientation. The four camera positions can be represented as (x_{c1}, y_{c1}, z_{c1}), (x_{c2}, y_{c2}, z_{c2}), (x_{c3}, y_{c3}, z_{c3}), and (x_{c4}, y_{c4}, z_{c4}) with respect to Venue origin of the scene volume captured by the four cameras as shown in FIG. 4. The synthesis of a full 3D model for a single instance or scene of the full-motion video can be created by mathematically combining the color and/or brightness plus depth information from the four cameras. A convenient representation of the resulting model is a voxel format. A voxel (volumetric pixel or Volumetric Picture Element) could be represented by a three-dimensional position and color and/or brightness at that position.

Each camera will capture the image plus depth from its respective position, these can be represented by (R_{c1(i,j)}, G_{c1(i,j)}, B_{c1(i,j)}, d_{c1(i,j)}), (R_{c2(i,j)}, G_{c2(i,j)}, B_{c2(i,j)}, d_{c2(i,j)}), (R_{c3(i,j)}, G_{c3(i,j)}, B_{c3(i,j)}, d_{c3(i,j)}), and (R_{c4(i,j)}, G_{c4(i,j)}, B_{c4(i,j)}, d_{c4(i,j)}), where (i,j) is the pixel location in the plane of the image capture. FIG. 3 on page 4 in the referenced paper “REAL-TIME CREATION AND DISSEMINATION OF DIGITAL ELEVATION MAPPING PRODUCTS USING TOTAL SIGHT™ FLASH LiDAR”, Eric Coppock, et. al., ASPRS 2011 Annual Conference, Milwaukee, Wis., May 1-5, 2011 (http://www.asprs.org/a/publications/proceedings/Milwaukee2011/files/Coppock.pdf) shows how the Total Sight LiDAR camera captures image plus depth. They also use geo-location to generate a Digital Elevation Map (DEM) for their mapping applications. By having calibrated the cameras with respect to location and orientation, it is possible to translate the image plus depth information into the frame of reference of the captured volume of space, through the use of simple homogenous coordinate transformations.

The homogenous coordinate transformation is computed in the following steps. First, the location of a point on the object being captured is computed from the pixel location in the camera of the image and the distance of that pixel from the object. Second, this location is then translated so that it is within the frame of reference of the venue itself. The multiple cameras are positioned relative to this venue frame of reference. This puts all of the data in the same frame of reference so that the data can be combined into a single representation of the real-world action.

FIG. 3 shows how the image plus depth information from the LIDAR camera is transformed from into the frame of reference for the camera, identified as the Center of Focus. The Focal Plane is where the image sensor is placed, distance f from the Center of Focus. The image coordinate (x′,y′) represents the pixel location of the image, the distance d represents the distance from the Focal Plane to the object. The location of the object is represented by the point (x″,y″,z″) relative to the Center of Focus. The location of the object relative to the Center of Focus is computed by:

$${x}^{″} = \frac{( {f}_{d} + d )}{{f}_{d}} {x}^{′}$$

$${y}^{″} = \frac{( {f}_{d} + d )}{{f}_{d}} {y}^{′}$$

$${z}^{″} = \frac{( {f}_{d} + d )}{{f}_{d}} f$$

This can be represented as a homogenous coordinate transform:

$$[ \begin{matrix}{x}^{″} \\ {y}^{″} \\ {z}^{″} \\ {f}_{d}\end{matrix} ] = [ \begin{matrix}( {f}_{d} + d ) & 0 & 0 & 0 \\ 0 & ( {f}_{d} + d ) & 0 & 0 \\ 0 & 0 & ( {f}_{d} + d ) & 0 \\ 0 & 0 & 0 & {f}_{d}\end{matrix} ] \cdot [ \begin{matrix}{x}^{′} \\ {y}^{′} \\ f \\ 1\end{matrix} ]$$

Performing the perspective divide by f_{d} gives the final object location of (x″,y″,z″). This transform will be referenced as Transform 1 in the following discussion.

FIG. 3 To translate the object location (x″,y″,z″) from the camera to the venue reference origin (xₒ,yₒ,zₒ), both the camera location and the camera orientation are needed. For the case of four cameras located at the cardinal directions (North, South, East, West) of the venue the transformation involves a translation and rotation of 90 degrees. Since the rotation is 90 degrees, the transformation is equivalent to substituting one axis for another, as illustrated in FIG. 4. Thus, in the case of the camera C₁, while the X″-axis of the frame of reference of the camera is the same as the X-axis of the frame of reference with respect to the venue, the Z″-axis becomes the −Y-axis of the venue, and the Y″-axis becomes the Z-axis of the venue. Similar translation and rotation of 90 degrees will be involved when objects imaged by cameras C₂, C₃ and C₄ are transformed into the frame of reference of the venue. When there are additional cameras with different orientations (e.g. NE, NW, SE, SW) one or more rotations of 45 degrees is included in the transformation to place the orientation of the data in the context of venue as well. Still more additional cameras may be added to those at the NE, NW, SE, SW corners if desired, where the rotation angles will need to be adjusted depending on the orientations of these cameras with respect to the frame of reference of the venue.

FIG. 4 shows a view from above the venue showing the location of the four cameras relative to the Venue Origin, shown as (x_{c1},y_{c1},z_{c1}), (x_{c2},y_{c2},z_{c2}), (x_{c3},y_{c3},z_{c3}), and (x_{c4},y_{c4},z_{c4}). For purposes of discussion we will consider the object location (xₒ,yₒ,zₒ) as one that is visible from camera C₁.

The following discussion develops the homogenous coordinate transform providing the translation from camera C₁ reference to venue reference. As shown in FIG. 3, the frame of reference for each of the cameras has the z-axis pointed in the direction the camera is pointed, the y-axis pointing up (out of the page in FIG. 4) and the x-axis pointing left as one looks in the direction the camera is pointed (z-axis). Since this transform is from the orientation of the camera (z-axis is oriented along the camera view) it also rotates the orientation to align with the venue (z-axis is oriented up from the ground). The transforms are represented by the equations below. As can be seen the z-value of the voxel of the object from the venue frame of reference is calculated in all cases by adding the y-value from the frame of reference of the camera to the z-value of the camera location. The x-values and y-values of the voxel from the venue frame of reference will either have the x-value or z-value from the camera frame of reference added or subtracted from the camera location x-value or y-value depending on the camera orientation. The transform for camera C₁ represents the following equations:

xₒ=x″₁+x_{c1} yₒ=−z″₁+y_{c1} zₒ=y″₁+z_{c1}

where x″₁, z″₁ and y″₁ are respectively the x, y and z coordinate positions of the voxel in the frame of reference of the camera C₁ that is being transformed. The corresponding homogenous coordinate transform, identified as Transform 2, that transforms a point from the frame of reference of camera C₁ into the common venue frame of reference is:

$$[ \begin{matrix}{x}_{o} \\ {y}_{o} \\ {z}_{o} \\ 1\end{matrix} ] = [ \begin{matrix}1 & 0 & 0 & {x}_{c 1} \\ 0 & 1 & 0 & {y}_{c 1} \\ 0 & 0 & 1 & {z}_{c 1} \\ 0 & 0 & 0 & 1\end{matrix} ] \cdot [ \begin{matrix}{x}_{1}^{″} \\ - {z}_{1}^{″} \\ {y}_{1}^{″} \\ 1\end{matrix} ]$$

In a similar manner, we can develop the corresponding transforms for other points on the object from the other cameras (x₂, y₂, z₂), (x₃, y₃, z₃), and (x₄, y₄, z₄). The following transforms translate points on the object in the frame of reference of cameras C₂, C₃, and C₄ respectively.

$$[ \begin{matrix}{x}_{o} \\ {y}_{o} \\ {z}_{o} \\ 1\end{matrix} ] = [ \begin{matrix}1 & 0 & 0 & {x}_{c 2} \\ 0 & 1 & 0 & {y}_{c 2} \\ 0 & 0 & 1 & {z}_{c 2} \\ 0 & 0 & 0 & 1\end{matrix} ] \cdot [ \begin{matrix}- {z}_{2}^{″} \\ {x}_{2}^{″} \\ {y}_{2}^{″} \\ 1\end{matrix} ] \\ [ \begin{matrix}{x}_{o} \\ {y}_{o} \\ {z}_{o} \\ 1\end{matrix} ] = [ \begin{matrix}1 & 0 & 0 & {x}_{c 3} \\ 0 & 1 & 0 & {y}_{c 3} \\ 0 & 0 & 1 & {z}_{c 3} \\ 0 & 0 & 0 & 1\end{matrix} ] \cdot [ \begin{matrix}- {x}_{3}^{″} \\ {z}_{3}^{″} \\ {y}_{3}^{″} \\ 1\end{matrix} ] \\ [ \begin{matrix}{x}_{o} \\ {y}_{o} \\ {z}_{o} \\ 1\end{matrix} ] = [ \begin{matrix}1 & 0 & 0 & {x}_{c 4} \\ 0 & 1 & 0 & {y}_{c 4} \\ 0 & 0 & 1 & {z}_{c 4} \\ 0 & 0 & 0 & 1\end{matrix} ] \cdot [ \begin{matrix}{z}_{4}^{″} \\ {x}_{4}^{″} \\ {y}_{4}^{″} \\ 1\end{matrix} ]$$

where x″ₙ, z″ₙ and y″ₙ are respectively the x, y and z coordinate positions of the voxel in the frame of reference of the camera Cₙ that is being transformed, n=2, 3 or 4. In order for the data to be assembled correctly, the four cameras need to be synchronized so that they capture the same scene in a time sequence of scenes in the live event at precisely the same time and do this sequentially over time at all of the scenes in the time sequence at a certain frame rate.

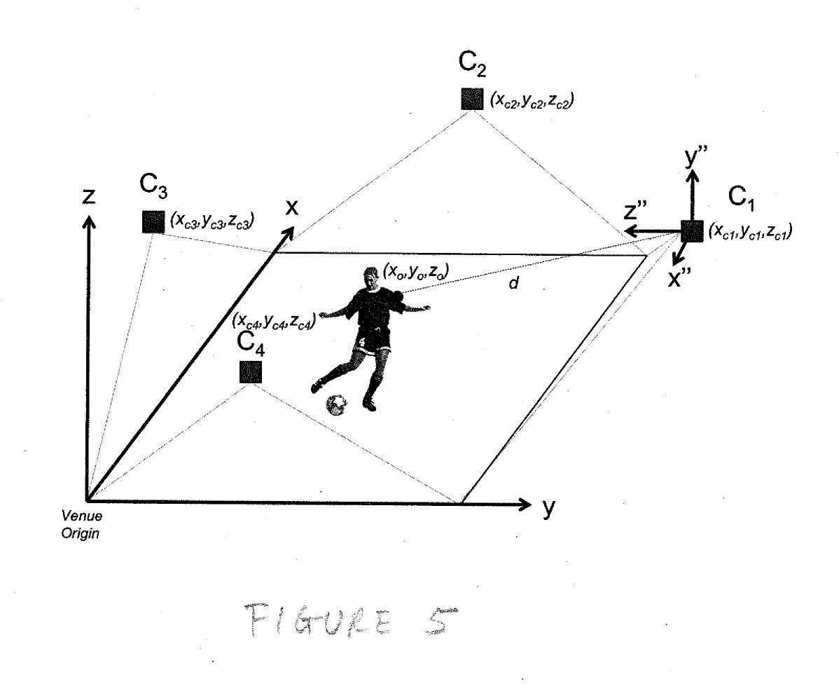

FIG. 5 shows an alternative view of the four spatially diverse cameras capturing live action.

The resulting data can be represented by the color plus 3D location of the resulting voxel, represented by (R_{vc1(i,j)}, G_{vc1(i,j)}, B_{vc1(i,j)}, X_{vc1(i,j)}, Y_{vc1(i,j)}, Z_{vc1(i,j)}) for Red, Green, Blue colors and X, Y, Z location for the voxel corresponding to camera 1 and pixel (i,j). Correspondingly, the other camera voxel data is represented by (R_{vc2(i,j)}, G_{vc2(i,j)}, B_{vc2(i,j)}, X_{vc2(i,j)}, Y_{vc2(i,j)}, Z_{vc2(i,j)}), (R_{vc3(i,j)}, G_{vc3(i,j)}, B_{vc3(i,j)}, X_{vc3(i,j)}, Y_{vc3(i,j)}, Z_{vc3(i,j)}), and (R_{vc4(i,j)}, G_{vc4(i,j)}, B_{vc4(i,j)}, X_{vc4(i,j)}, Y_{vc4(i,j)}, Z_{vc4(i,j)}). Stitching together all of these voxels into the volume captured provides a virtual three-dimensional model of the scene. This process is repeated at the frame rate (30 fps or 60 fps for example) to create a real-time virtualized representation of the live action occurring within the venue.

There are many potential stitching algorithms that could be applied. For example, the color value for a particular voxel could be a blend (i.e. average) of the colors from all of the cameras that produce a voxel at that 3 dimensional location. Another alternative is that the voxel representation provides an independent color on each face of the voxel corresponding to the direction from which the voxel is seen. With more cameras at different perspectives the number of contributing R,G,B values increases and different approaches could be taken to blend them together. The same can be done for the brightness value at the voxel, in addition to the color, by applying similar stitching algorithms. Antialiasing or filtering techniques could also be used to smooth the image and spatial representation making the resulting rendering less jagged or blocky.

Once a full motion, complete three-dimensional model, with color imaging of a live event, is captured, it is then possible to render the action from any perspective or point on the view. In the same way a game console could be used to visualize a virtual world, it is possible to visualize the virtualized representation of the real world. There are numerous books that detail the rendering process for 3D games, e.g. “Mathematics for 3D Game Programming and Computer Graphics, Third Edition”, Eric Lengyel, Jun. 2, 2011, ISBN-10: 1435458869, ISBN-13: 978-1435458864. In addition to rendering the action on typical two-dimensional display, it is possible to render the action in three-dimensions using stereographic displays or other three-dimensional rendering techniques.

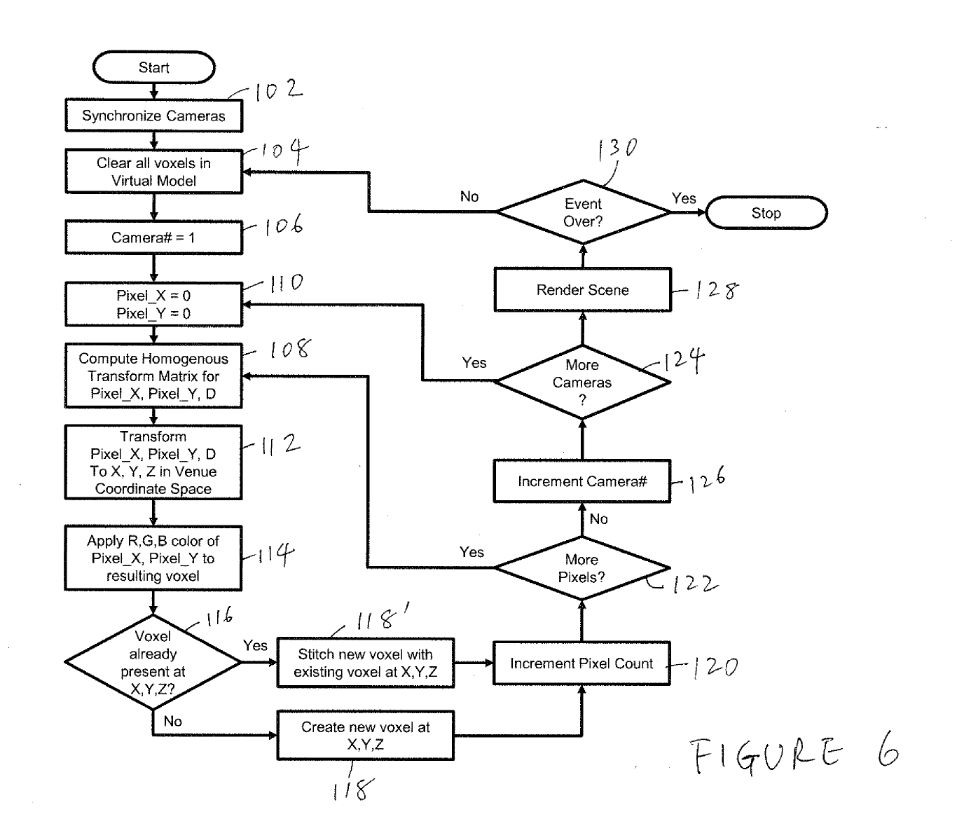

FIG. 6 shows a flowchart of the process of creating the complete three-dimensional model and rendering it. The outside loop of this flowchart is executed at the frame rate desired, for example, either 30 times-per-second or 60 times-per-second.

As shown in FIG. 6, a number of cameras are employed to capture 2D images plus depth of scenes in a time sequence of scenes in the event, and the cameras are synchronized so that when triggered, they will acquire images of the same scene at the same time (Block 102). All voxels in a virtual 3D model are cleared (block 104), The 2D images plus depth information of a number of cameras need to be transformed to the venue frame of reference. The first camera from which the images are to be processed is identified as camera 1 (block 106). The x and y coordinates of the first pixel in a 2D image of camera 1 will need to be transformed to the venue frame of reference. The pixel_x and pixel_y counts of this first pixel are set to zero (block 110) and a transform matrix is computed for the current pixel and the current camera (block 108). The x and y coordinates of the first pixel plus the depth of this pixel are transformed using the equations set forth above to a potential voxel at the X, Y, Z location in the venue frame of reference (block 112). Color of this potential voxel is arrived at by applying the R, G, B color of the first pixel (block 114). The system queries as to whether this is the first voxel in the virtual model at If this is the first voxel at the X, Y, Z location in the venue frame of reference (diamond 116). Since this is the first voxel at the X, Y, Z location, the answer to this query is “NO” and the system proceeds to create the X, Y, Z location in the venue frame of reference (block 118). Pixel_x and pixel_y counts are then incremented by 1 for the second pixel from camera 1 (block 120).

The system queries as to whether there are more pixels to be processed from camera 1 (diamond 122). Since there are more pixels to be processed from camera 1, the answer is “YES” and the system returns to block 112 to transform the x, y coordinates of the second pixel different from the first pixel from camera 1 to a potential voxel at the X, Y, Z location in the venue frame of reference (block 112). The same process as described above for the first pixel in blocks/diamonds 114, 116, 118, 120, 122 is repeated, and the system then processes the third pixel information from camera. This process continues until all the pixels from camera have been processed, and the virtual model now has as many voxels created as the number of pixels from camera 1.

When all of the pixels from camera 1 have been processed, the answer to the query in diamond 122 will be no, and the system queries as to whether there is at least one more other camera with pixels to be processed (diamond 124). If there is at least one more, such as camera 2 different from camera 1, then the system proceeds to block 126 to increment the camera count by 1 and then to block 112 to process pixels from camera 2. In this instance, a pixel from camera 2 being processed may be at a location that is the same as that of a voxel already created in block 118 from the pixels from camera 1, when this location is visible to both cameras 1 and 2. In that case, instead of creating a new voxel in block 118, the system stitches the new potential voxel from blocks 112 and 114 and the voxel already created at the same location (block 118′) into a merged voxel, such as by blending the colors and/or brightness of the two voxels, for example. If, however, no voxel has been created at the location of the potential voxel from blocks 112 and 114 transformed from a pixel from the second camera, a new voxel is created with the color and/or brightness of the potential voxel created in the block 112 and 114. This means that this location is not visible by camera but is visible by camera 2, so that only the color and/or brightness of the pixel from the second camera is taken into account in creating the voxel in the virtual model. The process continues until all pixels from the second camera have been processed.

The system proceeds to process pixels from additional cameras, if any, until the pixels from all cameras have been processed in the manner described above (diamond 124), to create a virtual 3D model of one scene in a live event that was imaged substantially simultaneously by a number of cameras. This process is repeated for each of the scenes in the event from images acquired at a particular frame rate, to create a time sequence of virtual 3D models of voxels, each with a color attribute and/or a brightness attribute.

The virtual model so created is then used to render (block 128) scenes to re-enact the live event. This rendering continues until rendering of the event is over (block 130).

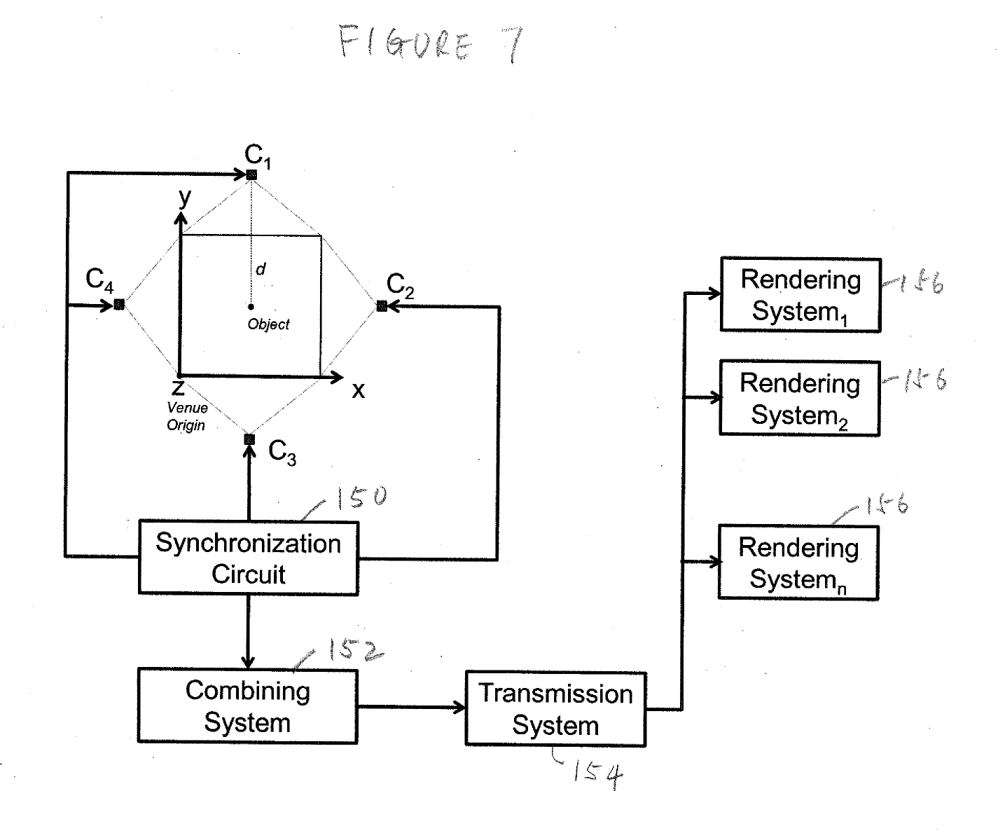

FIG. 7 is a block diagram of a system that captures full motion live events in color using spatially distributed depth sensing cameras, and reproduces the live events from any perspective. As shown in FIG. 7, four cameras C₁, C₂, C₃ and C₄ are used to acquire 2D plus depth information from a live event. The four cameras are synchronized by means of the synchronization circuit 150, which also collects the 2D images and depth information from the cameras, and supplies them to a combining system 152. Combining system or device 152 preferably includes a microprocessor executing software that performs the process shown in FIG. 6 to create a time sequence of virtual 3D models of voxels, which are transmitted to n rendering systems 156 of n users, n being any positive integer by a transmission system 154. The rendering system could be a 3D game console, or a personal computer, or a specialized rendering device.

The rendering can be simply to provide video of the event as a sequence of 2D images from a perspective chosen by a user, where each of the n users may select a perspective different from those of the other users. It can also provide a stereoscopic display. This can be achieved by rendering twice using the sequence of 3D models, one for the left eye and one for the right eye, separate by the average distance between the eyes in humans.

Although the various aspects of the present invention have been described with respect to certain preferred embodiments, it is understood that the invention is entitled to protection within the full scope of the appended claims.

1. A system for creating real-time, full-motion, three-dimensional models for reproducing a live event, comprising:
a plurality of depth sensing cameras acquiring a time sequence of two-dimensional images plus depth information of the event from a plurality of different viewing directions;
a circuit synchronizing the plurality of depth sensing cameras to acquire the two-dimensional images plus depth information of each of at least some scenes in the event substantially simultaneously; and
a device combining the two-dimensional images plus depth information acquired by the plurality of depth sensing cameras substantially simultaneously to create a time sequence of three-dimensional models of the live event.

2. The system of claim 1, said depth sensing cameras comprising LIDAR cameras.

3. The system of claim 1, wherein said plurality of depth sensing cameras are placed at locations acquiring images plus depth information of the event from viewing directions that cover at least 90 degree surrounding view of the event.

4. The system of claim 1, wherein said device transforms information on the event acquired by the plurality of depth sensing cameras into a common frame of reference.

5. The system of claim 4, wherein said device generates a set of three dimensional voxels from a two-dimensional image plus depth information of each scene in a time sequence of scenes of the event acquired by each of a corresponding one of the plurality of depth sensing cameras and transforms said sets of three dimensional voxels into said common frame of reference in creating said three-dimensional models of the live event.

6. The system of claim 5, wherein said device merges the voxels that have a common location and that are generated from two-dimensional images plus depth information of the same scene in said time sequence of scenes acquired by the plurality of depth sensing cameras to obtain a single merged voxel in said common frame of reference.

7. The system of claim 6, wherein said device assigns characteristics of each of the merged voxels by combining the characteristics of the voxels from which said merged voxel is obtained.

8. The system of claim 7, wherein said device assigns characteristics of at least one of said merged voxels by blending characteristics of voxels from which said at least one merged voxel is obtained and that have been generated from two-dimensional images plus depth information acquired from more than one depth sensing camera in the instance when the location of the at least one merged voxel is visible from more than one depth sensing camera among the plurality of depth sensing cameras.

9. The system of claim 7, wherein said device assigns characteristics of at least one of said merged voxels by assigning characteristics of one of the voxels from which said at least one merged voxel is obtained and that has been generated from a two-dimensional image plus depth information acquired by one of said depth sensing cameras in the instance when the location of the at least one merged voxel is visible only from said one depth sensing camera among the plurality of depth sensing cameras.

10. The system of claim 7, wherein said characteristics include color or brightness, or both color and brightness.

11. The system of claim 1, wherein said device transmits the sequence of three-dimensional models to a plurality of rendering systems for display to a plurality of end-users.

12. The system of claim 11, wherein said rendering systems use said three-dimensional models to provide full color display of the live event from any perspective in the event as selected by the respective end-users, each end-user potentially selecting a different vantage point or perspective of the event.

13. The system of claim 12, wherein said rendering systems present either simple two-dimensional displays or stereoscopic displays as selected by the respective end-users, each end-user potentially selecting either one or the other form of display.

14. A method for creating real-time, full-motion, three-dimensional models for reproducing a live event, by means of a plurality of depth sensing cameras, said method comprising:
using said plurality of depth sensing cameras to acquire a time sequence of two-dimensional images plus depth information of the event from a plurality of different viewing directions, wherein the acquiring of said two-dimensional images plus depth information of each of at least some scenes in the event by the cameras occurs substantially simultaneously; and
combining the time sequence of two-dimensional images plus depth information acquired by the plurality of depth sensing cameras to create a time sequence of three-dimensional models of the live event.

15. The method of claim 14, further comprising placing said plurality of depth sensing cameras at locations acquiring images plus depth information of the event from viewing directions that cover at least 90 degree surrounding view of the event.

16. The method of claim 14, wherein said combining includes transforming information on the event acquired by the plurality of depth sensing cameras into a common frame of reference.

17. The method of claim 16, wherein said transforming includes generating a set of three dimensional voxels from a two-dimensional image plus depth information of each scene in a time sequence of scenes of the event acquired by each of a corresponding one of the plurality of depth sensing cameras and transforms said sets of three dimensional voxels into said common frame of reference in creating said three-dimensional models of the live event.

18. The method of claim 17, wherein said combining merges the voxels that have a common location and that are generated from two-dimensional images plus depth information of the same scene in said time sequence of scenes acquired by the plurality of depth sensing cameras to obtain a single merged voxel in said common frame of reference.

19. The method of claim 18, wherein said combining assigns characteristics of each of the merged voxels by combining the characteristics of the voxels from which said merged voxel is obtained.

20. The method of claim 19, wherein said combining assigns characteristics of at least one of said merged voxels by blending characteristics of voxels from which said at least one merged voxel is obtained and that have been generated from two-dimensional images plus depth information acquired from more than one depth sensing camera in the instance when the location of the at least one merged voxel is visible from more than one depth sensing camera among the plurality of depth sensing cameras.

21. The method of claim 19, wherein said combining assigns characteristics of at least one of said merged voxels by assigning characteristics of one of the voxels from which said at least one merged voxel is obtained and that has been generated from a two-dimensional image plus depth information acquired by one of said depth sensing cameras in the instance when the location of the at least one merged voxel is visible only from said one depth sensing camera among the plurality of depth sensing cameras.

22. The method of claim 19, wherein said characteristics include color or brightness, or both color and brightness.

23. The method of claim 14, further comprising transmitting the sequence of three-dimensional models to a plurality of rendering systems for display to a plurality of end-users.

24. The method of claim 23, wherein said rendering systems use said three-dimensional models to provide full color display of the live event from any perspective in the event as selected by the respective end-users, each end-user potentially selecting a different vantage point or perspective of the event.

25. The method of claim 24, wherein said rendering systems present either simple two-dimensional displays or stereoscopic displays as selected by the respective end-users, each end-user potentially selecting either one or the other form of display.

26. A system for providing real-time, full-motion, three-dimensional models for reproducing a live event, comprising:
a plurality of depth sensing cameras acquiring a time sequence of two-dimensional images plus depth information of the event from a plurality of different viewing directions;
a circuit synchronizing the plurality of depth sensing cameras to acquire the two-dimensional images plus depth information of each of at least some scenes in the event substantially simultaneously;
a device combining the two-dimensional images plus depth information acquired by the plurality of depth sensing cameras substantially simultaneously to create a time sequence of three-dimensional models of the live event; and
a plurality of rendering systems reproducing said live event from the time sequence of three-dimensional models for display to a plurality of end-users.

27. The system of claim 26, wherein said rendering systems use said three-dimensional models to provide full color display of the live event from any perspective in the event as selected by the respective end-users, each end-user potentially selecting a different vantage point or perspective of the event.

28. The system of claim 27, wherein said rendering systems present either simple two-dimensional displays or stereoscopic displays as selected by the respective end-users, each end-user potentially selecting either one or the other form of display.
